(19) United States
(12) Patent Application Publication
(10) Pub. No.: US 2018/0205762 A1
(43) Pub. Date: Jul. 19, 2018

(54) AUTOMATICALLY SECURING DATA BASED ON GEOLOCATION, NETWORK OR DEVICE PARAMETERS

(71) Applicant: Vaultize Technologies Private Limited, Pune (IN)

(72) Inventors: Ankur Panchbudhe, Pune (IN); Praneeth Siva, Pune (IN); Amol Vaikar, Pune (IN); Yusuf Batterywala, Pune (IN)

(73) Assignee: Vaultize Technologies Private Limited, Pune (IN)

(21) Appl. No.: 15/918,847

(22) Filed: Mar. 12, 2018

(51) Int. Cl. H04L 29/06; G06F 21/62

(52) U.S. Cl. CPC H04L 63/205; G06F 21/62; G06F 2221/2147; G06F 2221/2141; G06F 2221/2143

(57) ABSTRACT

Disclosed herein are a method and a system for securing data in user devices. The system collects on a real time or periodic basis, certain trigger input (s) required for securing data in the user device. The trigger inputs may include but not limited to geolocation, network and network parameter information corresponding to the user device being monitored. Further, by processing the collected trigger input (s) the system identifies at least one action to be triggered to secure data in the user device. Further, the selected action (s) is executed at the user device, to secure the data in the user device.

### TECHNICAL FIELD

The embodiments herein relate to data protection and containerization and, more particularly, to securing of data automatically based on geolocation, network or device parameters.

### BACKGROUND

Most of the companies nowadays offer a Bring Your Own Device (BYOD) facility, which allows employees to use their own devices (laptops, tablets, mobile phones and so on) for official use. This can be considered to be good for the company, as they do not have to invest much for providing resources to the employees. From the employee perspective, this option is useful as they can access data even if they are out of office.

However, BYOD option gives rise to data security concerns. Work related information is normally of a confidential nature, and BYOD allows users to access the confidential data from anywhere. Further, malware threats also add to the data security concerns. In any organization, network security mechanisms are employed in the form of anti-virus software, anti-malware applications and so on to protect the network and devices from any imminent threats. However, personal devices of the employees may not be equipped with such security means, and are prone to malware attacks, which in turn may result in data loss.

Data leak prevention means can be used as a solution to this problem. This mechanism is intended to restrict user access to data under certain circumstances. Data containerization technique is used to separate enterprise data from personal data, in the user device, and in a way, may lock down access to the enterprise data, by securing the enterprise data. However, the current systems, which are being used for data containerization and securing data, provide limited options for customizing the data securing options. The existing containerization systems containerize the whole device or the whole application, thus causing inconvenience to the users. Further, the existing containerization systems need to be manually turned ON, and are not proactive in nature.

### BRIEF DESCRIPTION OF THE FIGURES

The embodiments herein will be better understood from the following detailed description with reference to the drawings, in which:

FIG. 1 illustrates a block diagram of a data security management system, as disclosed in the embodiments herein;

FIG. 2 illustrates the components of a secured user device, as disclosed in the embodiments herein;

FIG. 3 illustrates a plurality of components of a user device 103, as disclosed in the embodiments herein;

FIG. 4 illustrates the data management engine, as disclosed in the embodiments herein;

FIG. 5 is a flow diagram that depicts various steps involved in the process of securing data using the data security management system, as disclosed in the embodiments herein; and

FIG. 6 is a flow diagram that depicts various steps involved in the process of securing data, as disclosed in the embodiments herein, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

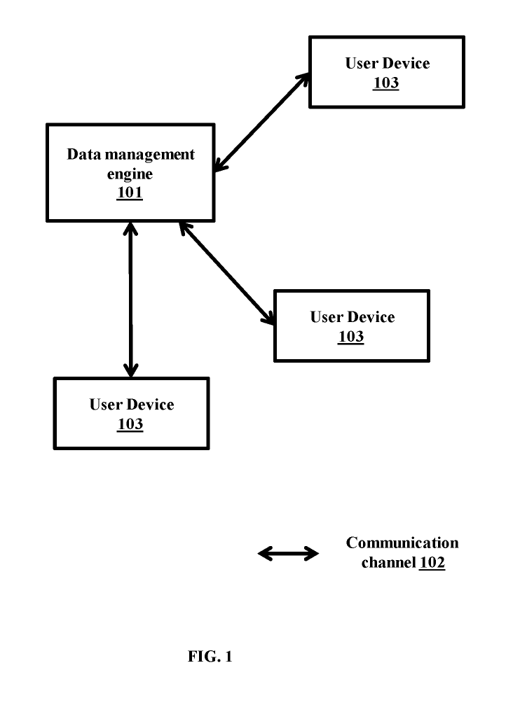

The embodiments herein disclose a mechanism for securing data by using a data security management system. Referring now to the drawings, and more particularly to FIGS. 1 through 6, where similar reference characters denote corresponding features consistently throughout the figures, there are shown embodiments.

FIG. 1 illustrates a block diagram of a data security management system, as disclosed in the embodiments herein. The data security management system comprises of a data management engine 101, at least one communication channel 102, and at least one user device 103. The communication channel 102 can be used to establish communication between the data management engine 101 and the user device 103. The communication channel 102 can be at least one of a wired connection means, a wireless connection means, or a suitable combination thereof. The user device 103 can be a device that enables a user to view, access or edit data (wherein the data may be present locally in the user device 103, or in a remote location such as a remote server, the Cloud, and so on). Examples of the data management engine 101 can be, but not limited to, at least one of a computer, a laptop, a tablet, a mobile phone, a smart phone, a wearable computing device, an Internet of Things (IoT) device, or any other device that can be used by the user to access data.

The data management engine 101 can communicate with the user device 103 through the communication channel 102, to manage data security on the user device 103. In an embodiment herein, the user device 103 can secure the data on the user device, based on one or more communications received from the data management engine 101. In an embodiment herein, the user device 103 can secure the data itself, based on performing a comparison with one or more policies stored locally.

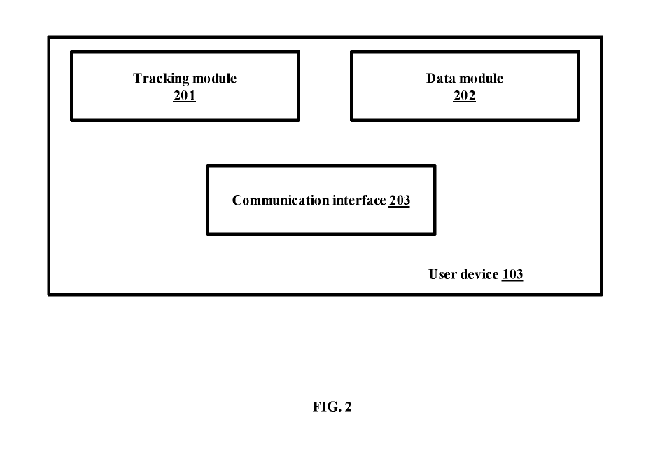

FIG. 2 shows the user device, as disclosed in the embodiments herein. The user device 103 further comprises of a tracking module 201, a data module 202, and at least one communication interface 203. The device 103 can further comprise of one or more sensors and/or modules, wherein the sensors and/or modules can track various parameters and information related to the user device 103. The sensors can track the location of the user device 103 using any suitable means such as GPS (Global Positioning System), triangulation, Wi-Fi, and so on. The sensors can collect information related to the user device 103, such as user name, user account, operating system (OS), device characteristics, applications present on the device 103, applications currently being accessed on the device 103, and so on. The sensors can also collect information related to one or more networks serving the user device 103, such as the network(s) serving the user device 103, network availability, signal strength, whether the network is secured/unsecured, and so on. Examples of the information related to the network and the device parameters may be, but not limited to, IP (Internet Protocol) address, network SSID GSM/CDMA network parameters, other network parameters such as MAC (Media Access Control) address, GPRS/3G/4G, device ID, and so on.

The tracking module 201 can receive/fetch information from the sensor(s) and/or modules (hereinafter referred to as trigger inputs). The trigger inputs can comprise of the geolocation of the user device 103, information related to one or more networks serving the user device 103, information collected related to the user device 103, and so on. The tracking module 201 can communicate the trigger inputs to the communication interface 203.

The communication interface 203 can comprise of one or more interfaces that enable the user device 103 to communicate with external entities, such as the data management engine 101. The communication interfaces 203 can use a wired and/or a wireless means for communicating with the external entities. The communication interface 203 can communicate with the tracking module 201 to collect the trigger inputs. The communication interface 203 can communicate the trigger inputs received from the tracking module to the data management engine 101. The communication interface 203 can also receive one or actions to be performed by the user device 101 from the data management engine 101.

The data module 202 can perform at least one action that is required to secure data in the user device 103, as instructed by the data management engine 101. The communication interface 203 can perform selected action(s) for securing the data, as instructed by the data management engine 101.

In an embodiment herein, the data module 202 can process the trigger inputs, identify and select at least one action to be triggered so as to perform the data securing process. If the data management engine 101 has provided a key, the data module 202 can use the key to decrypt/encrypt the data, based on the communication from the data management engine 101.

The device 103 can comprise of a data storage means, which can be used to store all or at least a portion of the policies and any other information required to perform the data securing process. This can be useful in scenario such as the user device 103 being unable to communicate with the data management engine 101.

In an embodiment herein, the data module 202 can process the trigger inputs based on at least one policy stored in the local data storage means. The data module 202, by processing the trigger inputs, can identify and select at least one action to be triggered so as to perform the data securing process. Examples of the action can be, but not limited to, deletion of the data, hiding the data, secure wiping of the data, DRM protection of the data, lockdown/scrambling of the data, blocking of user access to the data, containerization of the data, or any other equivalent means to secure the data.

The data module 202 can fetch the policy from another entity such as the data management engine 101, a remote server, the Cloud, a data server, and so on. On fetching the policy, the data module can store the policy. The data module 202 can update the policy, as required, wherein the updation can include addition, deletion, editing of the policy, and so on.

For example, if the policy states that the data has to be accessed only when the user device 103 is present in an office premises, then the data module 202 can check if the current location of the device 103 is within the office premises. If the device 103 is within the office premises, the data module 202 can decrypt the data and enable the user of the user device 103 to access the data. If the device 103 is not within the office premises, the control module 401 can encrypt the data and block access to the data.

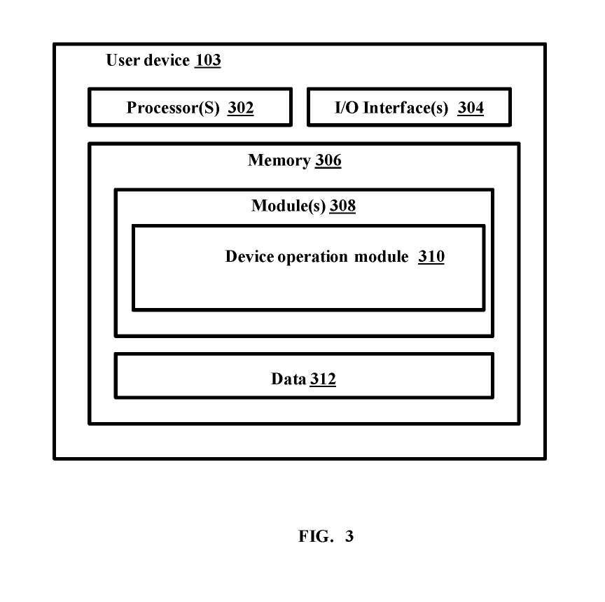

FIG. 3 illustrates a plurality of components of a user device 103. Referring to FIG. 3, the user device 103 is illustrated in accordance with an embodiment of the present subject matter. In an embodiment, the user device 103 may include at least one processor 302, an input/output (I/O) interface 304 (herein a configurable user interface), and a memory 306. The at least one processor 302 may be implemented as one or more microprocessors, microcomputers, microcontrollers, digital signal processors, central processing units, state machines, logic circuitries, and/or any devices that manipulate signals based on operational instructions. Among other capabilities, the at least one processor 302 can be configured to fetch and execute computer-readable instructions stored in the memory 306.

The I/O interface 304 may include a variety of software and hardware interfaces, for example, a web interface, a graphical user interface such as a display screen, a camera interface for the camera sensor (such as the back camera and the front camera on the user device 103), and the like.

The I/O interface 304 may allow the user device 103 to communicate with other devices, such as the data management engine 101. The I/O interface 304 may facilitate multiple communications within a wide variety of networks and protocol types, including wired networks, for example, Local Area network (LAN), cable, etc., and wireless networks, such as Wireless LAN, cellular, Device to Device (D2D) communication network, Wi-Fi networks and so on. The modules 308 include routines, programs, objects, components, data structures, and so on, which perform particular tasks, functions or implement particular abstract data types.

In one implementation, the modules 308 may include a device operation module 310. The device operation module 310 can be configured to perform at least one action such as securing at least some or all of the data 312, present in the user device 103.

In an embodiment herein, the device operation module 310 can be configured to secure the data, based on one or more instructions/actions received from the data management engine 101. The device operation module can be configured to execute one or more tasks such as collecting information from one or more sensors present in the user device 103 and sharing the collected information with the data management engine 101. The device operation module can be configured to execute one or more tasks corresponding to the application on the user device 103 in accordance with the instructions received from the data management engine 101.

In an embodiment herein, the device operation module 310 can process the trigger inputs based on at least one policy stored in the memory 306. The data module 202, by processing the trigger inputs, can identify and select at least one action to be triggered so as to perform the data securing process. Examples of the action can be, but not limited to, deletion of the data, hiding the data, secure wiping of the data, DRM protection of the data, lockdown/scrambling of the data, blocking of user access to the data, containerization of the data, or any other equivalent means to secure the data.

The modules 308 may include programs or coded instructions that supplement applications and functions of the user device 103. The data 312, amongst other things, serves as a repository for storing data processed, received, and generated by one or more of the modules 308. The device operation module 310 can secure the data 312, based on instructions received from the data management engine 101. Further, the names of the other components and modules of the user device 103 are illustrative and need not be construed as a limitation.

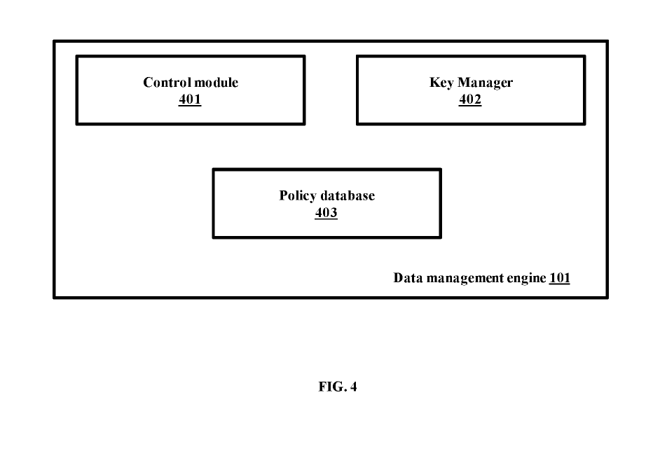

FIG. 4 is a block diagram showing various components of the data management engine, as disclosed in the embodiments herein. The data management engine 101 further comprises of a control module 401, a Key Manager (KM) 402, and a policy database 403. The policy database 403 can comprise of one or more policies and/or configurations. An authorized user, such as a user with administrator privileges, can configure the policies. The policies can be defined based on one or parameters such as the current location of the device 103, the network that is being used the device 103, the user using the device 103, applications present on the device 103, applications that are being accessed currently on the device 103, and so on.

The control module 401 can be configured to receive the trigger inputs from the user device 103 and process the received trigger inputs based on at least one policy stored in the policy database 403. The control module 401, by processing the trigger inputs, can identify and select at least one action to be triggered so as to perform the data securing process. Examples of the action can be, but not limited to, deletion of the data, hiding the data, secure wiping of the data, DRM protection of the data, lockdown/scrambling of the data, blocking of user access to the data, containerization of the data, or any other equivalent means to secure the data.

For example, if the policy states that the data has to be accessed only when the user device 103 is present in an office premises, then the control module 401 can check if the current location of the device 103 is within the office premises. If the device 103 is within the office premises, the control module 401 can communicate to the device 103 to decrypt the data and enable the user of the user device 103 to access the data. If the device 103 is not within the office premises, the control module 401 can communicate to the device 103 to encrypt the data and block access to the data.

The KM 402 can generate at least one key, which can be used to encrypt and/or decrypt data in the user device 103, if encryption/decryption is selected as the action to be triggered for data securing purpose. In another embodiment, the keys generated by the KM 402 can be used for data containerization. In another embodiment herein, the keys generated can be used for creating DRM (Digital Rights Management) schemes, which can be used to protect the data. In another embodiment herein, the keys generated can be used for providing secure access, such as blocking a user from accessing the server at network or machine level. The control module 401 can communicate the selected action(s) to the user device 103, with the generated key(s).

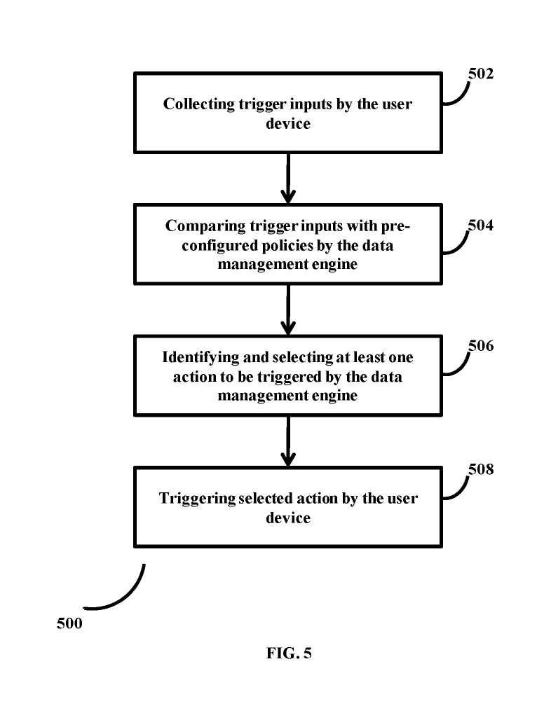

FIG. 5 is a flow diagram that depicts various steps involved in the process of securing data using the data security management system, as disclosed in the embodiments herein. The data security management system is configured to perform securing of data in the user device 103, based on parameters such as geolocation parameters, network parameters, and device parameters. For example, the network and device parameters that may be used for securing of data in the user device 103 are, but not limited to IP address, network SSID GSM/CDMA network parameters, other network parameters such as MAC (Media Access Control) address, GPRS/3G/4G, and device ID. Using the tracking module 201 in the user device 103, at least one of the geolocation, and/or network or device parameter is collected (502) as trigger input. The collected trigger input is then sent to the communication interface in the user device 103.

The control module 401 or the communication interface 203 compares (504) the trigger input with policies stored in the policy database 403. In an embodiment, each policy may refer to a rule or a set of rules that define type of action to be triggered corresponding to the trigger input received. For example, one policy may define data securing mode to be adopted corresponding to location of the user device 103, such as securing a portion of the data when the location of the user is determined to be in China, Libya, or any other country where the data may be at risk. In another example, the policy can define securing the data, when the IP and/or MAC address of the device is not approved. While comparing the trigger input with the policy, the control module 401 may compare location of the device as indicated by the trigger input, with location as defined by the policy, and then identifies (506) and selects at least one action as indicated by the policy. For example, the action to be triggered could be any of, or a suitable combination of wiping, secure wiping, hiding, encrypting, containerizing, DRM protection or lockdown. In an embodiment, such actions may be pre-defined and pre-configured by any authorized person such as an administrator, as per requirements. Various examples of actions that may be triggered by the control module 401 are, but not limited to wiping, secure wiping, hiding, encrypting, containerizing, DRM protection, and lockdown. Further, information about the selected action(s) to be triggered is sent to the user device 103 as instruction(s).

The communication interface 203 in the user device 103 receives the instruction, and further instructs the data module 202 to trigger the action(s) as instructed by the data management engine 101. The data module 202 then triggers (508) the selected action (s). In an embodiment, the data module 202 may be associated with suitable hardware and/or software means to execute any action that is supported by the data management engine 101, for the purpose of securing the data in the user device 103. For example, if the action to be triggered for the purpose of securing the data is encryption of the data in the user device 103, the data module 202 may be equipped with at least one means for encrypting the data. Further, the data module 202 may support encryption of different types of data such as but not limited to file, folder, image, contact, email, and any metadata associated with the data.

The various actions in method 500 may be performed in the order presented, in a different order or simultaneously. Further, in some embodiments, some actions listed in FIG. 5 may be omitted.

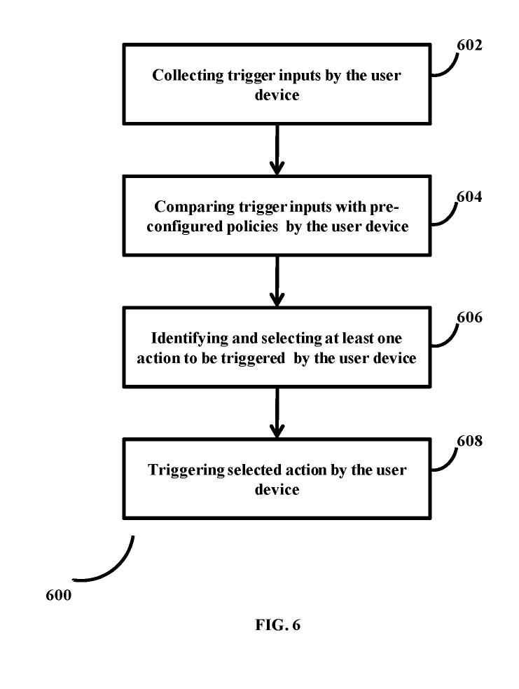

FIG. 6 is a flow diagram that depicts various steps involved in the process of securing data, as disclosed in the embodiments herein. The user device 103 can secure data present in it, based on parameters such as geolocation parameters, network parameters, and device parameters. For example, the network and device parameters that may be used for securing of data in the user device 103 are, but not limited to IP address, network SSID GSM/CDMA network parameters, other network parameters such as MAC (Media Access Control) address, GPRS/3G/4G, and device ID. Using the tracking module 201 in the user device 103, at least one of the geolocation, and/or network or device parameter is collected (602) as trigger input. The user device 103 compares (604) the trigger input with policies stored locally. In an embodiment, each policy may refer to a rule or a set of rules that define type of action to be triggered corresponding to the trigger input received. For example, one policy may define data securing mode to be adopted corresponding to location of the user device 103, such as securing a portion of the data when the location of the user is determined to be in China, Libya, or any other country where the data may be at risk. In another example, the policy can define securing the data, when the IP and/or MAC address of the device is not approved. While comparing the trigger input with the policy, the user device 103 may compare location of the device as indicated by the trigger input, with location as defined by the policy, and then identifies (606) and selects at least one action as indicated by the policy. For example, the action to be triggered could be any of, or a suitable combination of wiping, secure wiping, hiding, encrypting, containerizing, DRM protection or lockdown. In an embodiment, such actions may be pre-defined and pre-configured by any authorized person such as an administrator, as per requirements. Various examples of actions that may be triggered by the control module 401 are, but not limited to wiping, secure wiping, hiding, encrypting, containerizing, DRM protection, and lockdown. The user device 103 then triggers (608) the selected action(s) using the data module 202. In an embodiment, the data module 202 may be associated with suitable hardware and/or software means to execute any action that is supported by the data management engine 101, for the purpose of securing the data in the user device 103. For example, if the action to be triggered for the purpose of securing the data is encryption of the data in the user device 103, the data module 202 may be equipped with at least one means for encrypting the data. Further, the data module 202 may support encryption of different types of data such as but not limited to file, folder, image, contact, email, and any metadata associated with the data.

The various actions in method 600 may be performed in the order presented, in a different order or simultaneously. Further, in some embodiments, some actions listed in FIG. 6 may be omitted.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for securing data, the method comprising
collecting at least one trigger input by a user device, wherein the at least one trigger input comprises location of the user device, information related to the user device, and information related to one or more networks serving the user device;
communicating the at least one trigger input to a data management engine by the user device;
identifying at least one policy related to the data by the data management engine, based on the received at least one trigger input;
communicating the at least one determined policy to the user device by the data management engine; and
perform at least one action on the data by the user device, in response to the received at least one determined policy.

2. The method, as claimed in claim 1, wherein the method further comprises of the data management engine identifying the at least one identified pre-defined policy by comparing the at least one trigger input to at least one stored pre-defined policy.

3. The method, as claimed in claim 1, wherein the at least one action performed on the data comprises at least one of deletion of the data, hiding the data, secure wiping the data, applying Digital Rights Management (DRM) protection to the data, lockdown/scrambling of the data, encrypting the data, decrypting the data, blocking of user access to the data and containerization of the data.

4. The method, as claimed in claim 1, wherein the method further comprises
generating a key by the data management engine, wherein the key is used for at least one of securing the data;
communicating the generated key to the user device with the at least one determined policy by the data management engine; and
encrypting/decrypting the data by the user device using the generated key.

5. A system for securing data, the system comprising
at least one user device configured for
collecting at least one trigger input, wherein the at least one trigger input comprises location of the user device, information related to the user device, and information related to one or more networks serving the user device; and
communicating the at least one trigger input to a data management engine;
the data management engine configured for
identifying at least one policy related to the data, based on the received at least one trigger input; and
communicating the at least one determined policy to the user device; and
the at least one user device further configured for
performing at least one action on the data, in response to the received at least one determined policy.

6. The system, as claimed in claim 5, wherein the data management engine is further configured for identifying the at least one identified pre-defined policy by comparing the at least one trigger input to at least one stored pre-defined policy.

7. The system, as claimed in claim 5, wherein the at least one action performed on the data by the user device comprises at least one of deletion of the data, hiding the data, secure wiping the data, applying Digital Rights Management (DRM) protection to the data, lockdown/scrambling of the data, encrypting the data, decrypting the data, blocking of user access to the data and containerization of the data.

8. The system, as claimed in claim 5, wherein the data management engine is further configured for
generating a key, wherein the key is used for at least one of securing the data; and
communicating the generated key to the user device with the at least one determined policy.

9. The system, as claimed in claim 8, wherein the user device is further configured for encrypting/decrypting the data using the generated key.

10. A data management engine configured for
receiving at least one trigger input from a user device, wherein the at least one trigger input comprises location of the user device, information related to the user device, and information related to one or more networks serving the user device; and
identifying at least one policy related to the data by comparing the at least one trigger input to at least one stored pre-defined policy; and
communicating the at least one determined policy to the user device.

11. The data management engine, as claimed in claim 8, wherein the data management engine is further configured for
generating a key, wherein the key is used for at least one of securing the data; and
communicating the generated key to the user device with the at least one determined policy.

12. A method for securing data, the method comprising
collecting at least one trigger input by a user device, wherein the at least one trigger input comprises location of the user device, information related to the user device, and information related to one or more networks serving the user device;
identifying at least one policy related to the data by the user device, based on the received at least one trigger input; and
perform at least one action on the data by the user device, in response to the at least one determined policy.

13. The method, as claimed in claim 12, wherein the method further comprises of the user device identifying the at least one identified pre-defined policy by comparing the at least one trigger input to at least one stored pre-defined policy.

14. The method, as claimed in claim 1, wherein the at least one action performed on the data comprises at least one of deletion of the data, hiding the data, secure wiping the data, applying Digital Rights Management (DRM) protection to the data, lockdown/scrambling of the data, encrypting the data, decrypting the data, blocking of user access to the data and containerization of the data.

15. A device for securing data present on the device, the device configured for
collecting at least one trigger input, wherein the at least one trigger input comprises location of the user device, information related to the user device, and information related to one or more networks serving the user device; and
identifying at least one policy related to the data, based on the received at least one trigger input; and
performing at least one action on the data, in response to the received at least one determined policy.

16. The device, as claimed in claim 15, wherein the user device is further configured for identifying the at least one identified pre-defined policy by comparing the at least one trigger input to at least one stored pre-defined policy.

17. The device, as claimed in claim 15, wherein the at least one action performed on the data by the user device comprises at least one of deletion of the data, hiding the data, secure wiping the data, applying Digital Rights Management (DRM) protection to the data, lockdown/scrambling of the data, encrypting the data, decrypting the data, blocking of user access to the data and containerization of the data.
